(19) United States
(12) Patent Application Publication
(10) Pub. No.: US 2007/0273623 A1
(43) Pub. Date: Nov. 29, 2007

(54) Method and apparatus using a dual axis optical dithering system to increase a perceived resolution of a display

(75) Inventors: Steven M. Penn, Plano, TX (US); Steven E. Smith, Coppell, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/441,847

(22) Filed: May 26, 2006

(51) Int. Cl. G09G 3/34

(52) U.S. Cl. 345/84

(57) ABSTRACT

According to one embodiment, a method of increasing a perceived resolution of a display includes directing light at an optical dithering system. The position of one or more optical elements associated with the optical dithering system is selectively alternated between a first set of positions relative to a first axis of rotation and a second set of positions relative to a second axis of rotation. As a result, light is alternately directed to at least four different locations on the display, thereby increasing the perceived resolution of the display.

### TECHNICAL FIELD OF THE INVENTION

This invention relates generally to display systems and more particularly to a method and system using a dual axis optical dithering system to increase a perceived resolution of a display.

### BACKGROUND OF THE INVENTION

Televisions and other types of displays are pervasive in today's society. Recent years have seen the introduction of higher definition displays. Engineers continue to try to increase the resolution of displays to provide better picture quality, but also face constraints associated with providing such increased resolution.

One approach for increasing the resolution of a display involves dithering. increasing a perceived resolution of a display by a user. Rather than providing more pixels, a first image is displayed including a set number of pixels corresponding to the same number of sample data points of the image to be displayed. Then at a time period very close to the display of the first image, a second image is displayed including the same number of pixels but with slightly different sample points of the image. This second image on the display is offset by a small amount from the display of the first image. The human eye perceives both images as being displayed at the same time, resulting in an effective doubling of the display resolution. This technique is referred to in the industry by many names including modulation, optical dithering, and SmoothPicture™.

### SUMMARY OF THE INVENTION

According to one embodiment, a method of increasing a perceived resolution of a display includes directing light at an optical dithering system. The position of one or more optical elements associated with the optical dithering system is selectively alternated between a first set of positions relative to a first axis of rotation and a second set of positions relative to a second axis of rotation. As a result, light is alternately directed to at least four different locations on the display, thereby increasing the perceived resolution of the display.

Some embodiments of the invention provide numerous technical advantages. Some embodiments may benefit from some, none, or all of these advantages. For example, according to one embodiment, a single optical element may be configured such that the position of the element is adjustable with respect to two independent axes of rotation. By selective manipulation of the optical element about the multiple axes of revolution, the image transmitted by the optical element may be displaced by ½ pixel and four on-screen pixels may be generated with a single DMD mirror. Because a single optical element is used to achieve the desired increase in resolution, however, the configuration of the optical dithering system may have a low number of part counts and require a relatively small amount of space in the projection path. Additionally, because the light is directed through or reflected by only a single optical element, lumens and contrast may be maintained at sufficient levels while perceived resolution is increased by a factor of at least four.

According to another embodiment, multiple, single-axis optical elements may be positioned in series to result in a similar manipulation of the light transmitted by and/or reflected by the optical elements. Specifically, by selectively manipulating each of the two optical elements about an independent axis of rotation, the image transmitted by the combined optical elements may be displaced by ½ pixel and four on-screen pixels may be generated with a single DMD mirror. Because two or more optical elements are used, however, crosstalk between the two axes of rotation may be minimized. Additionally, a greater degree of freedom and control may be obtained with respect to the movement of the respective optical elements. Because vibration modes are controlled, picture quality is improved.

Other technical advantages may be readily ascertainable by one of skill in the art.

### BRIEF DESCRIPTION OF THE FIGURES

For a more complete understanding of the invention, and for further features and advantages, reference is now made to the following description, taken in conjunction with the accompanying drawings, in which:

FIG. 1 is a schematic diagram illustrating a system for displaying light with increased perceived resolution using a multi-axis optical system, according to one embodiment of the invention;

FIGS. 2A-2C are schematic diagrams illustrating an example single element, multi-axis optical system, according to one embodiment of the invention;

FIG. 3 is a schematic diagram illustrating an example multi-element, multi-axis optical system, according to another embodiment of the invention; and

FIG. 4 is a flowchart illustrating an example method for displaying light with increased perceived resolution using a multi-axis optical system, according to one embodiment of the invention.

### DETAILED DESCRIPTION OF THE INVENTION

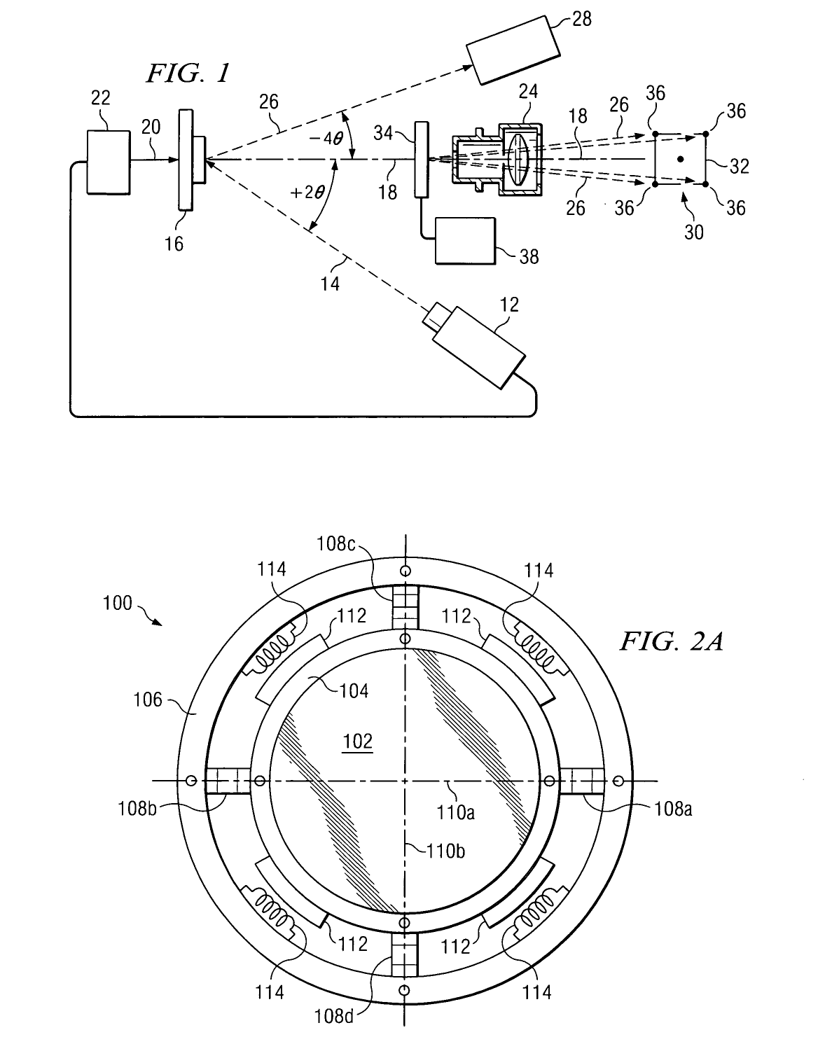

Embodiments of the invention and its advantages are best understood by referring to FIGS. 1-4 of the drawings, like numerals being used for like and corresponding parts of the various drawings.

FIG. 1 is a schematic diagram illustrating one embodiment of a portion of a projection display system 10 for displaying an image with increased perceived resolution. In this example, projection display system 10 includes a light source module 12 capable of generating illumination light beams 14. Light beams 14 are directed from light source module 12 to a modulator 16. Modulator 16 may comprise any device capable of selectively communicating at least some of the received light beams along a projection light path 18. In various embodiments, modulator 16 may comprise a spatial light modulator, such as, for example, a liquid crystal display or a light emitting diode modulator.

In this particular embodiment, modulator 16 comprises a digital micro-mirror device (DMD). The DMD is a micro electromechanical device comprising an array of hundreds of thousands of tilting micro-mirrors. According to one embodiment, the number of mirrors in the DMD is equal to the unenhanced resolution of image of a display 30. In a flat state, each micro-mirror may be substantially parallel to projection lens 24. From the flat state, the micro-mirrors may be tilted, for example, to a positive or negative angle to alternate the micro-mirrors between an “on” state and an “off” state. For discussion purposes, the angle at which the mirrors may tilt will be measured from projection path 18 and may be designated as theta. In particular embodiments, the micro-mirrors may tilt from +10 degrees to a −10 degrees. In other embodiments, micro-mirrors may tilt from a +12 degrees to a −12 degrees. To permit the micro-mirrors to tilt, each micro-mirror attaches to one or more hinges mounted on support posts, and spaced by means of an air gap over underlying control circuitry. The control circuitry provides electrostatic forces, based at least in part on image data 20 received from a control module 22. In various embodiments, modulator 16 is capable of generating various levels or shades for each color received.

The electrostatic forces cause each micro-mirror to selectively tilt. Incident illumination light on the micro-mirror array is reflected by the “on” micro-mirrors along projection path 18 for receipt by projection lens 24. Additionally, illumination light beams 14 are reflected by the “off” micro-mirrors and directed on off-state light path 26 toward light dump 28. The pattern of “on” versus “off” mirrors (e.g., light and dark mirrors) forms an image that is projected by projection lens 24. As used in this document, the terms “micro-mirrors” and “pixels” are used inter-changeably.

Light source module 12 includes one or more lamps or other light sources capable of generating and focusing an illumination light beam. In one embodiment, light source module 12 may sequentially generate light of different colors and provide those different colors in sequence to modulator 16 for projection by projection lens 24. The resulting image may be projected as display 30 that includes a plurality of pixels 32. Thus, light source module 12 may provide an array of light signals 14 for eventual display on display 16. Light source 12 and modulator 16 may cooperate to provide these different colors for appropriate time periods such that a user's eye viewing the light on display 30 will integrate the various colors to result in a desired color to be displayed.

Where modulator 16 includes a plurality of tilting micro-mirror devices, a tilt on the order of approximately +10 to +12 degrees will result in light source module 12 being in an “on” state. Conversely, a tilt on the order of approximately −10 to −12 degrees will result in light source module 12 being in an “off” state. Although display system 10 is described and illustrated as including a single light source module 12, it is generally recognized that display system 10 may include any suitable number of light sources modules appropriate for generating light beams for transmission to modulator 16.

In particular embodiments, light source module 12 is positioned such that light beam 14 is directed at modulator 16 at an illumination angle of twice theta (where theta is equal to the degree of tilt of the micro-mirror devices in the “on” state). For example, where the micro-mirror devices tilt from approximately +10 to +12 degrees (“on”) to approximately −10 to −12 degrees (“off”), light beam 14 may be directed at modulator 16 from light source module 12 positioned at an angle of approximately +20 to +24 degrees from projection path 18. Accordingly, light beam 14 may strike modulator 16 at an angle of approximately +20 to +24 degrees relative to the normal of the micro-mirrors when the micro-mirrors are in a flat state or an untilted position.

When the micro-mirror elements of modulator 16 are in the “on” state direction, illumination beam 14 is reflected approximately normal to the surface of projection lens 24 along illumination path 18. When the micro-mirror elements of modulator 16 are tilted in the “off” state direction, illumination light beam 14 from light source module 12 is reflected along off state light path 26 where it is received by light dump 28. Off state light path 26 is at a negative angle that is approximately equal to four times theta. Thus, where the micro-mirror devices are positioned at approximately −10 to −12 degrees when in the off state, light beam 14 is reflected at an angle of approximately −40 to −48 degrees as measured from projection path 18.

As discussed above, system 10 includes a control module 22 that receives and relays image data 20 to modulator 16 to effect the tilting of micro-mirrors in modulator 16. Specifically, control module 22 may relay image data 20 that identifies the appropriate tilt of the micro-mirrors of modulator 16. For example, control module 22 may send image data 20 to modulator 16 that indicates that the micro-mirrors of modulator 16 should be positioned in the “on” state. Accordingly, the micro-mirrors may be positioned at a tilt angle on the order of approximately +10 to +12 degrees, as measured from projection path 18. Alternatively, control module 22 may send image data 20 to modulator 16 that indicates that the micro-mirrors should be positioned in the “off” state. As such, the micro-mirrors may be positioned at a tilt angle on the order of approximately −10 to −12 degrees, as measured from projection path 18.

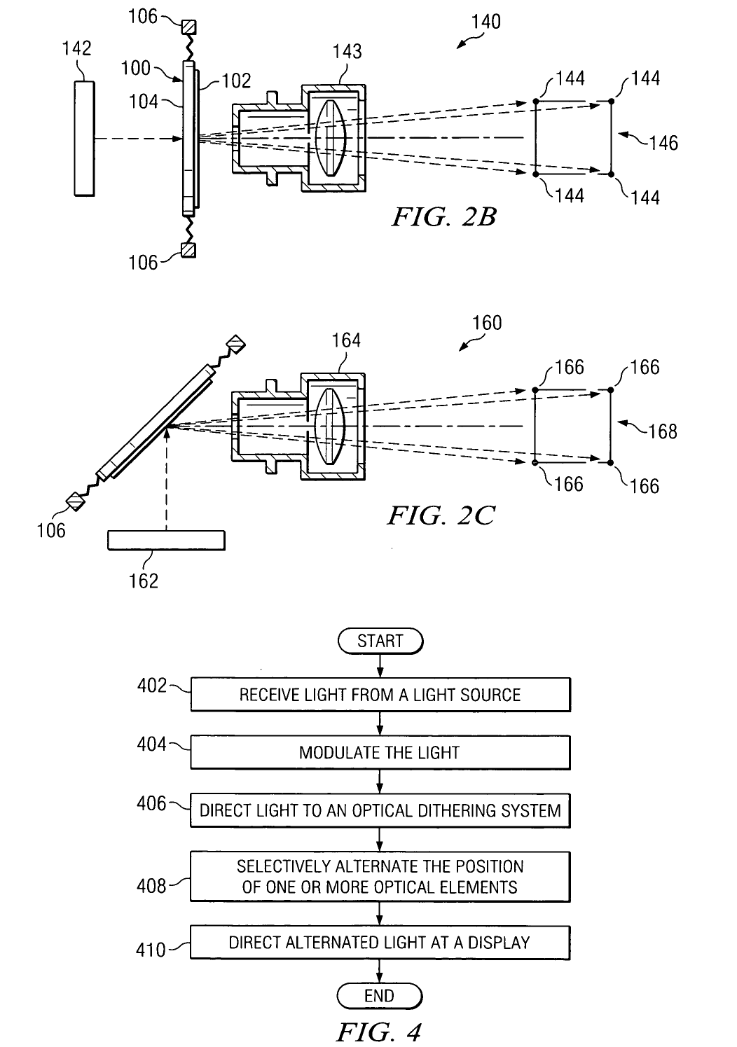

As will be described in more detail below with regard to FIGS. 2A-2C, 3, and 4, display system 10 includes a multi-axis optical dithering system 34 for displaying an image with increased perceived resolution. Optical dithering system 14 receives light signals along projection path 18 and transmits or reflects them onto display 16. As will be described in more detail below, optical dithering system 34 includes one or more optical elements, which may include one or more lenses, mirrors, or other devices or a combination lenses, mirrors, or other devices. The positions of the one or more optical elements are manipulated to result in the alternating transmission of light at multiple positions on display 16.

In operation, multi-axis optical dithering system 34 may selectively direct light to a desired location. In a particular embodiment, for example, optical dithering system 34 may include a dual-axis optical dithering system that directs light about two separate axes of rotation. In such an embodiment, multi-axis optical dithering system 34 selectively reflects light along projection path 18 to display 30 into one of four positions 36. Thus, a dual-axis optical dithering system produces an unoffset light beam 24 and three offset light beams 26 for display on display 30. If optical dithering system 34 is operated sufficiently rapidly to alternate light directed at the four positions 36, display 30 appears to have a resolution equal to four times the unenhanced resolution. As a result, a lower resolution DMD may be used in display system 10 without decreasing the resolution of the resulting display 30. It should be noted that the perceived resolution of display 30 may be increased by a factor of greater than four, if multi-axis optical dithering system 34 is configured to direct light using more than two axes of rotation. The teachings of the invention may be incorporated into such a system as well.

In particular embodiments, a controller 38 may be provided to result in the selective direction of light to the desired positions 36. Controller 38 may take any suitable form, such as an ASIC or an FPGA, and may be programmed to selectively position the optical elements of optical dithering system 34 in a desirable manner. In other embodiments, controller 38 may be omitted and optical dithering system 34 may receive signals from control module 22. Thus, in addition to controlling the operation of modulator 16, control module 22 may also operate to selectively position the one or more optical elements of optical dithering system 34 to result in the direction of light at positions 36.

As will be described in more detail below, the optical dithering system incorporated into display system 10 may include a single optical element or any appropriate arrangement of optical elements so long as the position of the one or more optical elements is selectively adjustable to result in the alternating direction of light to at least four different locations on the display, thereby increasing the perceived resolution of the display.

FIG. 2A illustrates an example multi-axis optical dithering system 100 according to one embodiment. In the illustrated embodiment, optical dithering system 100 is comprised of a single optical element 102 that is mounted or other-wise supported by a selectively adjustable hub-and-spoke frame. As descried above, optical element 102 may include a lens, mirror, or other device operable to selectively direct light to a desired location. Where optical element 102 includes a lens or other device that allows light to be transmitted through optical element 102, optical dithering system 100 is a refractive optical system. Conversely, where optical element 102 includes a mirror or other optical device that allows light to be reflected by optical element 102, optical dithering system 100 is a reflective optical system.

In a particular embodiment, optical element 102 may include a lens that has a thickness on the order of 3.50 mm. It is recognized, however, that optical element 102 may be of any appropriate thickness for transmitting or reflecting light at a desired position on display 30. For the manipulation of optical element 102 to selectively direction of light at the desired positions, optical element 102 may be mounted to an inner frame 104. An epoxy or other adhesive may be used to rigidly couple optical element 102 to inner frame 104. However, adhesive is just one mechanism that may be used to couple optical element 102 to inner frame 104; any other suitable mechanism or technique may be used to couple optical element 102 to inner frame 104 without departing from the scope of the present invention.

Inner frame 104 is coupled to an outer frame 106 by a plurality of spokes or webs 108. In a particular embodiment, inner frame 104 and outer frame 106 may be comprised of metal and plastic, respectively, and may have respective thicknesses on the order of approximately 0.15 and 0.25 inches. The provided dimensions and materials are mere examples, however. Any other materials of any appropriate dimensions may be used to provide to support to optical element 102. Spokes 108 form points of flexure that allow for the selective positioning of optical element 102 relative to the fixed outer frame 106. In a particular embodiment, for example, spokes 108 may include coils such as springs comprised of stainless steel and having a diameter on the order of 0.25 of an inch. Any other material of any appropriate dimensions may be used, however, to provide flexure to optical element 102. For example, in other embodiments, spokes 108 may include one or more corrugations or bends that may provide a desired amount of flexure to allow for the manipulative repositioning of optical element 102 relative to outer frame 106.

Spokes 108 may be positioned around the perimeter of optical element 102 such that each spoke 108 corresponds with and is opposite to another spoke 108, to form a pair of spokes. Each pair of spokes 108 may define an axis of rotation 110 associated with optical element 102 about which optical element 102 may be tilted. For example, in the illustrated embodiment, first and second spokes 108a and 108b may cooperate to define a first axis of rotation 110a about which optical element 102 may be tilted. Similarly, third and fourth spokes 108c and 108d may cooperate to define a second axis of rotation 110b about which optical element 102 may be tilted. Thus, the number of axes of rotation about which optical element 102 may be manipulated may be dependent upon the number of pairs of spokes arranged around the perimeter of optical element 102.

In operation, the position of optical element 102 may be alternately adjusted within the supportive hub-and-spoke arrangement relative to first axis of rotation 104 and second axis of rotation 106. For the selective adjustment of the position of optical element 102, optical dithering system 100 includes magnets 112 mounted on the outer perimeter of inner frame 104. In the illustrated embodiment, a magnet 112 is mounted between each spoke 108. Thus, optical dithering system 100 includes four magnets 112. Likewise, optical dithering system 100 includes four coils 114 mounted to outer frame 106 in positions that correspond generally with the positions of magnets 112. Thus, optical dithering system 100 includes four coil/magnet combinations.

By applying voltages to the coil/magnet combinations, the position of optical element 102 within inner frame 104 may be adjusted. When a voltage is applied to a particular coil 114, the direction of the resulting movement of optical element 102 may be determined by the respective polarities of the voltage and the magnet 112. For example, where a particular magnet 112 has a negative polarity and a negative voltage is applied to the corresponding coil 114, a repulsion may occur causing optical element 102 to tilt in a manner that increases the distance between the particular coil/magnet combination. A similar result may occur where the magnet 112 has a positive polarity and where a positive voltage is applied to the coil 114. Conversely, where a particular magnet 112 has a negative polarity and a positive voltage is applied to the corresponding coil 114 (or vice versa), an attraction may occur causing optical element 102 to tilt in a manner that decreases the distance between the particular coil/magnet combination.

Accordingly, by controlling the polarity and amount of the voltages applied to each coil 114 and the timing of such applications, the direction and position of optical element 102 may be adjusted relative to the position of fixed outer frame 106. In one embodiment, the application of a voltage to a particular coil 114 may cause optical element 102 to tilt at an angle on the order of 0.015 degrees. This corresponds to approximately four microns of vertical movement at the outer perimeter of optical element 102. In such an embodiment, the voltage applied to the coil 114 may be on the order of 60 to 120 hertz.

In operation, the application of voltages to coils 114 may cause optical element 102 to vibrate in a desired manner to cause light to be transmitted or reflected at desired angles between a plurality of positions on display 30. Where optical dithering system 100 includes a dual-axis optical element 102 such as that illustrated in FIG. 2A, the application of voltages to coils 114 may be controlled to cause optical element 102 to direct light between four positions associated with display 30. Specifically, voltages may be sequentially applied to coils 114 to cause the alternating tilt of optical element 102 between four positions. As a result, four light beams may be alternately directed to four positions 36 associated with display 30. If the position of optical element 102 is adjusted sufficiently rapidly between these four positions, display 30 appears to have a resolution equal to four-times the unenhanced resolution. As described above, however, the perceived resolution of display 30 may be increased more or less than four-times if optical element 102 is rotated about more or fewer axes of rotation than two.

As described above, optical dithering system 100 may include a refractive or reflective optical element 102, in particular embodiments. FIG. 2B illustrates a refractive single element, multi-axis optical dithering system 100 as included in a display system 140. Accordingly, light is directed from a modulator 142 toward optical dithering system 100. Because optical dithering system 100 is refractive, in the illustrated embodiment, the light received by optical dithering system 100 passes through optical element 102 and is directed in the general direction of a projector 143. As light is received by optical dithering system 100, however, the position of optical element 102 within optical dithering system 100 may be manipulated to result in light being transmitted through optical dithering system 100 toward four positions 144 on a display 146. As a result, four like images are only slightly offset from one another and are displayed within a very short time period. Accordingly, the human eye perceives all four images as being displayed at the same time, resulting an in effective quadrupling of the display resolution using a single, multi-axis refractive optical element.

FIG. 2C illustrates a reflective single element, multi-axis optical dithering system 100 as included in a display system 160. Similar to the refractive optical dithering system 100 of FIG. 2B, light is directed from a modulator 162 toward optical dithering system 100. Because optical dithering system 100 is reflective in the illustrated embodiment, however, the light received by optical dithering system 100 is reflected by optical element 102 in the general direction of a projector 164. As described above, as light is received by optical dithering system 100, the position of optical element 102 within optical dithering system 100 may be manipulated to result in light being transmitted through optical dithering system 100 toward four positions 166 on a display 168. Again, the human eye perceives all four reflected images as being displayed at the same time, resulting an in effective quadrupling of the display resolution using a single, multi-axis reflective optical element.

In the above described example embodiments, optical dithering system 100 includes a single, multi-axis optical element. It is generally recognized however, that other embodiments may include a configuration of multiple single or multi-axis optical elements that also operate to direct light at multiple positions upon a display, thereby improving the perceived resolution of the display. For example, a combination of two single-axis optical elements may be combined in series to result in the transmission of light at the multiple positions on the display. Such single-axis optical elements may include optical elements similar to those described above but configured to be reposition with respect to a single axis of rotation.

Alternatively, the optical dithering system may include a single-axis optical element mounted to the outer frame by fewer spokes than the optical dithering system 100 of FIG. 2A to result in fewer axes of rotation. For example, an optical dithering system 100 similar to that described above but with only two spokes joining the inner and outer frames may have only one axis of rotation about which the position of optical element may be adjusted. It is generally recognized, however, that other configurations of optical dithering systems 100 suitable to provide for the selective adjustment of optical element(s) may also be used without departing from the scope of the invention.

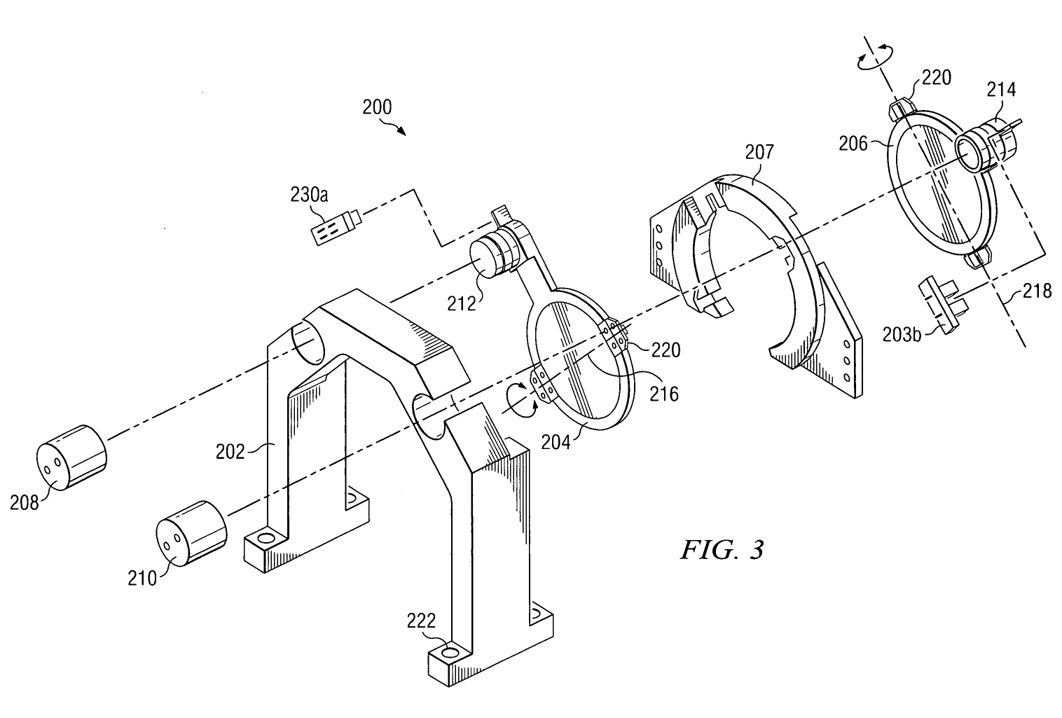

FIG. 3 illustrates an example multi-element, multi-axis optical dithering system 200 according to another embodiment of the invention. In the illustrated embodiment, optical dithering system 200 includes a frame 202 to which two single-axis optical elements 204 and 206 are mounted. A base assembly 207 separates the two optical elements. In a normal (unadjusted) position, optical elements 204 and 206 may lie parallel to each other in the same plane. The positions of each optical element 204 and 206 may then be adjusted about independent axes of rotation to result in the selective direction of light passing through optical elements 204 and 206.

Frame 202 is configured to include first and second VC elements 208 and 210 for controlling the position of optical elements 204 and 206, respectively. Specifically, first VC element 208 corresponds with a third VC element 212 associated with first optical element 204. Likewise, second VC element 210 corresponds with a fourth VC element 214 associated with second optical element 206. In particular embodiments, first and second VC elements 208 and 210 may include coils through which voltages may be applied. By contrast, third and fourth VC elements 212 and 214 may include magnets that operate to adjust the position of optical elements 204 and 206, respectively, when voltages are applied to first and second VC elements 208 and 210. Stated differently, first and third VC elements 208 and 212 may comprise a first coil/magnet combination, and second and third VC elements 210 and 214 may comprise a second coil/magnet combination.

In operation, when a voltage on the order of approximately 60 to 180 Hz is applied to first VC element 208, the polarity, amount, and duration of the voltage may result in the selective adjustment of first optical element 204 about a first axis of rotation 216. Conversely, when a voltage on the order of approximately 60 to 180 Hz is applied to second VC element 210, the polarity, amount, and duration of the voltage may result in the selective adjustment of second optical element 206 about a second axis of rotation 218. As was described above, the adjustment of each optical element may include the pivoting of the optical element about the respective axis of rotation by an amount on the order of approximately 0.5 to 2.0 degrees.

As illustrated, the mounting of first and second optical elements 204 and 206 to frame 202 is such as to provide first and second axes of rotation 216 and 218, which are offset from one another by approximately ninety degrees. It is generally recognized, however, that other configurations of optical dithering system 200 may result in the mounting of optical elements 204 and 206 to frame 202 such that the resulting first and second axes of rotation 216 and 218 are offset from one another by less than or more than ninety degrees. For example, where it is desirable to enhance the resolution of the display by a factor of six, three optical elements may be mounted in a series in an assembly similar to that illustrated in FIG. 3. In such an embodiment, the axis of rotation associated with each optical element may be offset from the other two elements by an amount on the order of 45 degrees.

Retaining springs 220 may be mounted to optical elements 204 and 206. Retaining springs 220 may operate to return first and second optical elements 204 and 206 to the normal position after a voltage has been applied and removed. Other structural components of optical dithering system 200 may include bolt holes 222 in frame 202 for the mounting of optical dithering system 200 within display system 10. For example, in particular embodiments, frame 202 may be mounted to a prism assembly (not shown in FIG. 1) positioned between the modulator and the projection lens.

In particular embodiments, optical dithering system 200 may include one or more feedback sensors 230 positioned on frame 202 to provide feedback information from optical elements 204 and 206. Specifically, a first feedback sensor 230a may provide an indication of the position of first optical element 204. A second feedback sensor 230b may provide an indication of the position of second optical element 206. Information from feedback sensors 230 may be provided to controller 38 or control module 22 for the selective adjustment of optical elements 204 and 206 with respect to first and second axes of rotation 216 and 218, respectively.

It is generally recognized that illustrated optical dithering system 200 is but one example of an optical dithering system that may be used for the selective adjustment of optical elements. Accordingly, although optical dithering system 200 is illustrated as including two single-axis optical elements 204 and 206, optical dithering system 200 may include additional single-axis optical elements where the increased resolution of the display is desirable. As described above, for example, where it is desirable to increase the perceived resolution of the display by a factor of approximately six times the unenhanced resolution, optical dithering system 200 may include three optical elements mounted to be manipulated about three independent axes of revolution.

In particular embodiments, it may be recognized that a dithering system that incorporates multiple single-axis optical elements may provide increased range of motion with respect to the produced beams of light. Because the structure described with regard to FIG. 3 is not a mechanically constraining fixture, the positioning of the transmitted light may be more controlled. Additionally, it is not difficult to change the direction or tilt of the optical elements in the described configuration since forces applied to first optical element 204 will not fight against forces applied to second optical element 206 when forces are applied to both optical elements at the same time.

FIG. 4 is a flowchart illustrating an example method for displaying light with increased perceived resolution using a multi-axis optical system, according to one embodiment of the invention. The method begins at step 402 when light is received from a light source. In particular embodiments, the light may be received at a modulator 16. At step 404 the light may be modulated. As discussed above, modulator 16 may comprise an array of micro-mirror devices that may be selectively positioned to receive the light. Accordingly, in particular embodiments, the modulation of the light received from the light source may include the tilting of one or more of the micro-mirror devices at an angle appropriate to receive the light and direct at least a portion of the light along projection path 18.

At step 406, the modulated light is directed to an optical dithering system 34. The optical dithering system generally includes an appropriate configuration of components to result in the direction of light at multiple positions with respect to a plurality of axes of rotations. In a particular embodiment, for example, optical dithering system 34 may include a dual-axis optical dithering system that directs light about two separate axes of rotation. As discussed above, optical dithering system 34 may include a single, multi-axis optical element that is selectively rotated about two axes of rotation associated with the single, multi-axis optical element. In other embodiments, optical dithering system 34 may include multiple, single-axis optical elements that are each selectively rotated about a single-axis of rotation.

The position of the one or more optical elements associated with optical dithering system 34 are selectively alternated at step 408. Specifically, the position of the one or more optical elements is alternated between a first set of positions relative to a first axis of rotation and a second set of positions relative to a second axis of rotation. Where the optical dithering system includes a single, multi-axis optical element, for example, the position of the single, multi-axis optical element is alternated between a first set of positions relative to a first axis of rotation and a second set of positions relative to a second axis of rotation. In this embodiment, the first and second axes of rotation are both associated with the single, multi-axis optical element.

In another embodiment, the selective alternating of the position of the optical dithering system 34 may include alternating the position of two optical elements. Each optical element may be tilted or otherwise rotated about an independent axis of rotation. In particular embodiments, where two optical elements are utilized in optical dithering system 34, the two axes of rotation may be approximately ninety degrees offset of one another.

In either embodiment, the alternated light may be directed at a display at step 410. Because the position of the one or more optical elements is alternated at a high rate of speed with respect to at least two axes of rotation, the alternated light is directed to at least four different locations on display 30. As a result, the perceived resolution of display 30 may be increased allowing for the use of a lower resolution modulator 16. If the light received at the display 30 is alternated sufficiently rapidly between the at least four positions 36, display 30 appears to have a resolution equal to four times the unenhanced resolution.

Although the present invention has been described in detail, it should be understood that the various changes, substitutions, and alterations could be made hereto without departing from the spirit and scope of the invention as defined by the appended claim.

What is claimed is:

1. A method of increasing a perceived resolution of a display comprising:
directing light by a digital micro-mirror imaging device at an optical dithering system;
selectively alternating the position of a single optical element associated with the optical dithering system, the position of the single optical element alternated between a first set of positions relative to a first axis of rotation associated with the optical element and a second set of positions relative to a second axis of rotation associated with the optical element; and
alternately directing light from the single optical element to four different locations on the display, thereby increasing the perceived resolution of the display.

2. A method of increasing a perceived resolution of a display comprising:
directing light by a digital micro-mirror imaging device at an optical dithering system;
selectively alternating the position of first and second optical elements associated with the optical dithering system, the position of the first optical element alternated between a first set of positions relative to a first axis of rotation associated with the first optical element, and the position of the second optical element alternated between a second set of positions relative to a second axis of rotation associated with the second optical element; and
alternately directing light from the first and second optical elements to four different locations on the display, thereby increasing the perceived resolution of the display.

3. A method of increasing a perceived resolution of a display comprising:
directing light at an optical dithering system;
selectively alternating the position of one or more optical elements associated with the optical dithering system, the position of the one or more optical elements alternated between a first set of positions relative to a first axis of rotation and a second set of positions relative to a second axis of rotation such that light is alternately directed to at least four different locations on the display, thereby increasing the perceived resolution of the display.

4. The method of claim 3, wherein selectively alternating the position of one or more optical elements comprises alternating a single optical element between the first set of positions relative to the first axis of rotation and the second set of positions relative to the second axis of rotation, the first and second axes of rotation associated with the single optical element.

5. The method of claim 4, wherein the single optical element comprises a refractive lens.

6. The method of claim 4, wherein the single optical element comprises a reflective mirror.

7. The method of claim 4, wherein selectively alternating the position of the single optical element comprises applying alternating a voltage applied to the optical element between four different sensors associated with the optical element.

8. The method of claim 3, wherein the one or more optical elements comprise a first optical element and a second optical element, and wherein selectively alternating the position of optical elements comprises:
alternating the position of the first optical element between the first set of positions relative to a first axis of rotation associated with the first optical element; and
alternating the position of the second optical element between the second set of positions relative to a second axis of rotation associated with the second optical element.

9. The method of claim 8, wherein the first and second optical elements comprise first and second refractive lenses.

10. The method of claim 8, wherein the first and second optical elements comprise first and second reflective mirrors.

11. The method of claim 8, wherein the first optical element comprises a refractive lens and the second optical element comprises a reflective mirror.

12. The method of claim 8, wherein selectively alternating the position of the first and second optical elements comprises alternately applying a voltage to the a first sensor associated with the first optical element and a second sensor associated with the second optical element.

13. The method of claim 3, wherein directing light comprises directing light by a digital micro-mirror imaging device.

14. A system for displaying an image on display comprising:
a light modulator operable to provide light indicative of an image to be displayed on the display;
an optical dithering system operable to receive light from the light modulator and direct the received light at the display; and
a controller operable to selectively alternate the position of one or more optical elements associated with the optical dithering system between a first set of positions relative to a first axis of rotation and a second set of positions relative to a second axis of rotation such that light is alternately directed to at least four different locations on the display, thereby increasing the perceived resolution of the display.

15. The system of claim 14, wherein the controller is operable to selectively alternate the position of the one or more optical elements by alternating a single optical element between the first set of positions relative to the first axis of rotation and the second set of positions relative to the second axis of rotation, the first and second axes of rotation associated with the single optical element.

16. The system of claim 15, wherein the single optical element comprises a refractive lens.

17. The system of claim 15, wherein the single optical element comprises a reflective mirror.

18. The system of claim 15, wherein the controller is operable to selectively alternate the position of the single optical element by alternatively applying a voltage applied to the optical element between four different sensors associated with the optical element.

19. The system of claim 14, wherein the one or more optical elements comprise a first optical element and a second optical element, and wherein the controller is further operable to:
alternate the position of the first optical element between the first set of positions relative to a first axis of rotation associated with the first optical element; and
alternate the position of the second optical element between the second set of positions relative to a second axis of rotation associated with the second optical element.

20. The system of claim 19, wherein the first and second optical elements comprise first and second refractive lenses.

21. The system of claim 19, wherein the first and second optical elements comprise first and second reflective mirrors.

22. The system of claim 19, wherein the first optical element comprises a refractive lens and the second optical element comprises a reflective mirror.

23. The system of claim 19, wherein the controller is further operable to selectively alternate the position of the first and second optical elements by alternately applying a voltage to the a first sensor associated with the first optical element and a second sensor associated with the second optical element.

24. The system of claim 14, wherein the light modulator comprises a digital micro-mirror imaging device.
